(19) United States
(12) Patent Application Publication
(10) Pub. No.: US 2014/0234655 A1
(43) Pub. Date: Aug. 21, 2014

(54) HOT-DIP GALVANIZED STEEL SHEET AND METHOD FOR PRODUCING SAME

(71) Applicant: JFE Steel Corporation, Tokyo (JP)

(72) Inventors: Katsutoshi Takashima, Tokyo (JP); Yuki Toji, Tokyo (JP); Nobusuke Kariya, Tokyo (JP); Kohei Hasegawa, Tokyo (JP)

(21) Appl. No.: 14/346,363

(22) PCT Filed: Sep. 27, 2012
(86) PCT No.: PCT/JP2012/006195

§ 371 Date: Mar. 21, 2014

(30) Foreign Application Priority Data
Sep. 29, 2011 (JP) 2011-215592

(51) Int. Cl. C23C 2/02; B32B 15/01

(52) U.S. Cl. CPC C23C 2/02; B32B 15/013
USPC 428/659; 148/533

(57) ABSTRACT

A high-strength hot-dip galvanized steel sheet has excellent workability, namely, excellent ductility and hole expansion formability, and high yield ratio. The steel sheet has a chemical composition containing by mass %: C: 0.05-0.15%; Si: 0.10-0.90%; Mn: 1.0-1.9%; P: 0.005-0.10%; S: 0.0050% or less; Al: 0.01-0.10%; N: 0.0050% or less; Nb: 0.010-0.100%; and the balance being Fe and incidental impurities, in which: the steel sheet has a complex phase that includes: ferrite having an average crystal grain size of 15 μm or less to at least 90% in volume fraction; martensite having an average crystal grain size of 3.0 μm or less to 0.5% or more and less than 5.0% in volume fraction; pearlite to 5.0% or less in volume fraction; and the balance being a phase generated at low temperature.

### TECHNICAL FIELD

This disclosure relates to a hot-dip galvanized steel sheet that is excellent in workability and has high yield ratio, and a method of producing/manufacturing the same. More particularly, the disclosure relates to a high-strength thin steel sheet that can be suitably applied to members for structural parts of automobiles. The yield ratio (YR) is a ratio of a yield strength (YS) with respect to a tensile strength (TS), which is represented by YR=YS/TS.

### BACKGROUND

In recent years, along with growing concern over environmental issues, CO₂ emission regulations are being further tightened, and improvement in fuel efficiency through reduction of automobile body weight has become a major issue in the automobile field. To this end, positive measures are taken to apply high-strength hot-dip galvanized steel sheets to automobile parts to reduce the thickness thereof, and application of steel sheets having a tensile strength (TS) level of at least 590 MPa is promoted.

High-strength hot-dip galvanized steel sheets for use in structural members and reinforcing members of automobiles are required to be excellent in stretch flangeability and ductility. In particular, steel sheets for use in members to be formed into complex shapes are insufficient to merely excel in only one of the properties such as elongation and stretch flangeability (hole expansion formability), but also required to be excellent in both of the properties.

Further, it may take some time before the manufactured hot-dip galvanized steel sheet is actually subjected to press forming, and it is important to keep the steel sheet from being deteriorated in elongation due to aging in the lapse of time. The steel sheets are also required to be high in impact energy absorption property. In this regard, it is effective to increase the yield ratio to improve the impact energy absorption property to efficiently absorb impact energy with small deformation.

In view of the above, to increase the strength of a steel sheet to obtain tensile strength of at least 590 MPa, it is effective to have hardened ferrite as the matrix phase, or to utilize hard phases such as martensite or retained austenite. In particular, a high-strength steel sheet which includes hardened ferrite obtained through precipitation-hardening with the addition of carbide forming elements such as niobium (Nb) is capable of reducing the need to add alloying elements for ensuring a predetermined strength, and thus can be manufactured at low cost.

For example, JP 3873638 B discloses a method of manufacturing a hot-dip galvanized steel sheet precipitation-hardened with addition of Nb and has a tensile strength of at least 590 MPa and excellent resistance to secondary working embrittlement after press forming. JP 2008-174776 A discloses a high-strength cold rolled steel sheet precipitation-hardened with addition of Nb and Ti and has a yield ratio larger than 0.70 and less than 0.92, excellent stretch-flangeability, and impact energy absorption property, and a manufacturing method thereof. Further, JP 2008-156680 A discloses a high-strength cold rolled steel sheet with a high tensile strength of at least 590 MPa precipitation-hardened by addition of Nb and Ti and has a steel sheet structure comprising recrystallized ferrite, unrecrystallized ferrite, and pearlite.

Meanwhile, the following are disclosed as methods of utilizing hard phases such as martensite and retained austenite. For example, JP 3887235 B discloses a high-strength steel sheet excellent in stretch flangeability and collision resistance property, which has a structure including ferrite as the main phase and martensite as the second phase, in which the maximum grain size of the martensite phase is 2 μm or less and the area ratio thereof is at least 5%. Further, JP 3527092 B discloses a high-strength hot-dip galvannealed steel sheet excellent in workability, in which the volume fractions of martensite and retained austenite are controlled, and a manufacturing method thereof.

However, according to JP '638, the steel sheet has insufficient ductility to ensure workability required in the aforementioned applications such as structural parts and reinforcing parts.

Further, according to JP '776, Al content in the steel sheet is less than 0.010%, which fails to perform sufficient deoxidation of the steel and fixation of N as precipitates, making it difficult to mass-produce sound steel. In addition, the steel contains oxygen (O) and has oxides dispersed therein, which leads to a problem that the steel varies considerably in material quality, in particular, in local ductility.

According to JP '680, unrecrystallized ferrite is uniformly dispersed to prevent deterioration in ductility, but the ductility thus obtained still fails to attain sufficient formability. JP '235, which utilizes martensite, gives no consideration to ductility. Further, JP '092, which utilizes martensite and retained austenite, provides a steel sheet with a yield ratio of less than 70%, and no consideration is given to the hole expansion formability.

As described above, it has been difficult to improve workability of a high-strength hot-dip galvanized steel sheet with high yield ratio, because the ductility and the hole expansion formability both need to be improved.

Therefore, it could be helpful to provide a high-strength hot-dip galvanized steel sheet excellent in workability, that is, excellent in both ductility and hole expansion formability, while having a high yield ratio, and also to provide a method of manufacturing the same.

### SUMMARY

We discovered that, in addition to enhancing precipitation using Nb, the average grain size and volume fraction of ferrite, the average grain size and volume fraction of martensite, and the volume fraction of pearlite in the microstructure of a steel sheet may be controlled to obtain a high-strength hot-dip galvanized steel sheet having high yield ratio of at least 70% and excellent workability. It has been hitherto considered, in terms of workability, that the presence of martensite in the steel sheet microstructure may improve elongation, but deteriorates hole expansion formability and even reduces the YR. However, we found out that the volume fraction and crystal grain size of martensite can be controlled, and the solid solution strengthening of ferrite through addition of Si and precipitation strengthening and crystal grain refinement through addition of Nb may be utilized to improve elongation and hole expansion formability without reducing YR while preventing deterioration in elongation due to aging.

Specifically, we found out that Nb, that is effective for precipitation strengthening which contributes to high yield ratio and high strength, can be added to 0.010% to 0.100%, and the steel sheet structure can be controlled to have the volume fraction of 90% or more for ferrite having an average crystal grain size of 15 μm or less, the volume fraction of 0.5% or more and less than 5.0% for martensite having an average crystal grain size of 3.0 μm or less, and the volume fraction of 5.0% or less for pearlite to obtain a high-strength hot-dip galvanized steel sheet having excellent workability and high yield ratio.

We thus provide:
(1) A hot-dip galvanized steel sheet having a chemical composition containing by mass %:
   C, 0.05% to 0.15%;
   Si: 0.10% to 0.90%;
   Mn: 1.0% to 1.9%;
   P: 0.005% to 0.10%;
   S: 0.0050% or less;
   Al: 0.01% to 0.10%;
   N, 0.0050% or less;
   Nb: 0.010% to 0.100%; and
   the balance being Fe and incidental impurities,
in which the steel sheet has a complex phase that includes:
   ferrite having an average crystal grain size of 15 μm or less to at least 90% in volume fraction;
   martensite having an average crystal grain size of 3.0 μm or less to 0.5% or more and less than 5.0% in volume fraction;
   pearlite to 5.0% or less in volume fraction; and
   the balance being a phase generated at low temperature, and
in which the steel sheet has a yield ratio of at least 70% and a tensile strength of at least 590 MPa.
(2) The hot-dip galvanized steel sheet according to item (1), further contains Nb-based precipitates having an average grain diameter of 0.10 μm or less.
(3) The hot-dip galvanized steel sheet according to item (1) or (2), further including, by mass %, in place of part of Fe component, 0.10% or less of Ti.
(4) The hot-dip galvanized steel sheet according to any one of items (1) to (3), in which a value obtained by dividing the volume fraction of ferrite having a grain size of 5 μm or less in the microstructure by the volume fraction of the entire ferrite in the microstructure of the steel sheet satisfies 0.25 or more.
(5) The hot-dip galvanized steel sheet according to any one of items (1) to (4), further including by mass %, in place of part of Fe component, at least one component selected from the following components:
   V: 0.10% or less;
   Cr: 0.50% or less;
   Mo: 0.50% or less;
   Cu: 0.50% or less;
   Ni: 0.50% or less; and
   B: 0.0030% or less.
(6) The hot-dip galvanized steel sheet according to any one of items (1) to (5), further including by mass %, in place of part of Fe component, at least one component selected from the following components:
   Ca: 0.001% to 0.005%; and
   REM: 0.001% to 0.005%.
(7) The hot-dip galvanized steel sheet according to any one of items (1) to (6), in which the galvanized coating is galvannealed coating.
(8) A method of manufacturing a hot-dip galvanized steel sheet, including,
   preparing a steel slab having the chemical compositions according to any one of items (1), (3), (5), and (6);
   hot rolling the steel slab under the conditions with a hot-rolling start temperature of 1,150° C. to 1,270° C. and a finish rolling completing temperature of 830° C. to 950° C. to be formed into a hot rolled steel sheet, which is cooled and then coiled at a coiling temperature within a range of 450° C. to 650° C.; which is pickled and then cold rolled to be formed into a cold rolled steel sheet;
   heating thereafter the cold rolled steel sheet at an average heating rate of at least 5° C./s to a temperature range of 650° C. or above;
   holding the heated steel sheet in a temperature range of 730° C. to 880° C. for 15 seconds to 600 seconds;
   subsequently cooling the held steel sheet at an average cooling rate of 3° C./s to 30° C./s to a temperature range of 600° C. or below;
   subjecting thereafter the cooled steel sheet to hot-dip galvanizing process to be formed into a hot-dip galvanized steel sheet; and
   cooling the hot-dip galvanized steel sheet to a room temperature.
(9) A method of manufacturing a hot-dip galvanized steel sheet, including:
   preparing a steel slab having the chemical compositions according to any one of items (1), (3), (5), and (6);
   hot rolling the steel slab under the conditions with a hot-rolling start temperature of 1,150° C. to 1,270° C. and a finish rolling completing temperature of 830° C. to 950° C. to be formed into a hot rolled steel sheet, which is cooled and then coiled at a coiling temperature within a range of 450° C. to 650° C.; which is pickled;
   heating thereafter the pickled steel sheet at an average heating rate of at least 5° C./s to a temperature range of 650° C. or above;
   holding the heated steel sheet in a temperature range of 730° C. to 880° C. for 15 seconds to 600 seconds;
   subsequently cooling the held steel sheet at an average cooling rate of 3° C./s to 30° C./s to a temperature range of 600° C. or below;
   subjecting thereafter the cooled steel sheet to hot-dip galvanizing process to be formed into a hot-dip galvanized steel sheet; and
   cooling the hot-dip galvanized steel sheet to a room temperature.
(10) The method of manufacturing a hot-dip galvanized steel sheet according to item (8) or (9), further including:
   subjecting the hot-dip galvanized steel sheet to galvannealing process in a temperature range of 450° C. to 600° C. after the hot-dip galvanizing process.

The chemical composition and the microstructure of a steel sheet can be controlled, to thereby stably obtain a high-strength hot-dip galvanized steel sheet having high yield ratio, which has a tensile strength of at least 590 MPa, a yield ratio of at least 70%, a total elongation of at least 26.5%, and a hole expansion ratio of at least 60%, and is excellent in elongation property and stretch flangeability with less degradation in elongation property due to aging.

### DETAILED DESCRIPTION

Our steel sheets and methods will be described in further detail hereinafter.

First, the reasons for restricting the content of each chemical component of the hot-dip galvanized steel sheet to the following ranges are described. In the following, the unit “%” of each chemical component below is “mass %” unless otherwise specified.

0.05%≦C≦0.15%

Carbon (C) is an element effective in enhancing the strength of the steel sheet. In particular, carbon is combined with a carbide-forming element such as niobium (Nb) to form a fine alloy carbide or a fine alloy carbonitride, to thereby contribute to enhancing the strength of the steel sheet. Further, carbon is an element necessary to form martensite and pearlite and contributes to enhancing the strength of the steel sheet. C content needs to be at least 0.05% to obtain these effects. On the other hand, C content of more than 0.15% leads to deterioration in spot weldability and, thus, the upper limit of C content is 0.15%. In view of ensuring more excellent weldability, C content may preferably be 0.12% or less.

0.10%≦Si≦0.90%

Silicon (Si) is an element which contributes to enhancing the strength of the steel sheet, and is also high in work hardenability to make the steel sheet less susceptible to deterioration in elongation in spite of an increase in strength, and thereby contributes to improving the strength/ductility balance. Further, Si has the effect of suppressing formation of voids in the interface between ferrite and martensite, or between ferrite and pearlite, through solid solution strengthening of the ferrite phase. Si content needs to be at least 0.10% to obtain the effect. In particular, Si content of 0.20% or more is preferably added in terms of the improvement in strength/ductility balance. On the other hand, Si content over 0.90% leads to significant deterioration in quality of hot-dip galvanized coating and, therefore, Si content is 0.90% or less, and preferably less than 0.70%.

1.0%≦Mn≦1.9%

Manganese (Mn) is an element which contributes to enhancing the strength of the steel sheet through solid solution strengthening and generation of the second phase. Mn content needs to be at least 1.0% to obtain the effect. On the other hand, Mn content over 1.9% results in an excessively high volume fraction of martensite or pearlite and, therefore, the Mn content needs to be 1.9% or less.

0.005%≦P≦0.10%

Phosphorus (P) is an element which contributes to enhancing the strength of the steel sheet through solid solution strengthening. P content needs to be at least 0.005% to obtain the effect. Meanwhile, P content over 0.10% causes significant segregation at the grain boundaries, with the result that the grain boundaries are embrittled and weldability is impaired. Therefore, P content is 0.10% or less. P content is preferably 0.05% or less.

S≦0.0050%

Too high a Sulfur (S) content produces sulfide such as MnS in large amount, which deteriorates local elongation typified by stretch flangeability and, thus, the upper limit of S content is 0.0050%. Although there is no need to specifically define the lower limit value of S content, excessively low content of S leads to an increase in steel production cost and, thus, S content needs to be reduced without falling below 0.0005%.

0.01%≦Al≦0.10%

Aluminum (Al) is an element effective in deoxidizing, and needs to be added to at least 0.01% to produce the deoxidizing effect. However, Al content exceeding 0.10% saturates the effect and, therefore, Al content is 0.10% or less. Al content is preferably 0.05% or less.

N≦0.0050%

Similarly to C, Nitrogen (N) is combined with niobium (Nb) to form a compound to be turned into an alloy nitride or an alloy carbonitride, to thereby contribute to enhancing the strength of the steel sheet. However, a nitride is likely to be generated at relatively high temperature and tends to be coarse, which makes a relatively smaller contribution to enhancing the strength as compared to a carbide. Further, solute N in the steel sheet has an effect of degrading the elongation after aging. For this reason, to attain high-strengthening and suppress deterioration in elongation after aging, it is advantageous to reduce N content to generate more alloy carbides. In view of this, N content is 0.0050% or less, preferably, 0.0040% or less.

0.010%≦Nb≦0.100%

Niobium (Nb) is combined with C or N to form a compound to be turned into a carbide or a carbonitride. Nb is also effective in grain-refinement of crystal grains, to thereby contribute to increasing the yield ratio and enhancing the strength of the steel sheet. Nb content needs to be at least 0.010% to obtain the effect, and more preferably at least 0.020%. However, Nb content larger than 0.100% results in significant deterioration in formability, and thus the upper limit value of Nb content is 0.100% or less, preferably 0.080% or less, and more preferably less than 0.050%.

In addition to the aforementioned basic components, the following optional components each may also be added within a predetermined range as necessary.

Ti≦0.10%

Similar to Nb, Titanium (Ti) forms a fine carbonitride and is also effective in grain-refinement of crystal grains to be capable of contributing to increasing the strength of the steel sheet and, thus. can be contained as necessary. However, a Ti content larger than 0.10% significantly deteriorates formability and, therefore, Ti content is 0.10% or less, preferably 0.05% or less. Meanwhile, in the case of adding Ti for the purpose of producing an effect of increasing the strength, Ti content may preferably be at least 0.005%.

V≦0.10%

Similar to Nb, vanadium (V) also forms a fine carbonitride, and has an effect of grain-refinement of crystal grains, while contributing to increasing the strength. Therefore, vanadium may be added as necessary. However, even if V content is increased to exceed 0.10%, there cannot be obtained a corresponding effect of increasing the strength commensurate with the increase above 0.10%, while causing a rise in alloy cost instead. Therefore, V content is 0.10% or less. Meanwhile, in the case of adding V for the purpose of producing an effect of increasing the strength, V content may preferably be at least 0.005%.

Cr≦0.50%

Chromium (Cr) is an element which contributes to enhancing the strength of the steel sheet by improving quench hardenability and generating the second phase, and may be added as necessary. Cr content is preferably at least 0.10% to obtain these effects. On the other hand, Cr content over 0.50% produces no further improvement in effectiveness and, therefore, Cr content is 0.50% or less.

Mo≦0.50%

Molybdenum (Mo) is an element which contributes to enhancing the strength of the steel sheet by improving quench hardenability and generating the second phase, and may be added as necessary. Mo content is preferably at least 0.05% to obtain the effect. On the other hand, Mo content over 0.50% produces no further improvement in effectiveness and, therefore, Mo content is 0.50% or less.

Cu≦0.50%

Copper (Cu) is an element which contributes to enhancing the strength of the steel sheet through solid solution strengthening and also by improving quench hardenability and generating the second phase, and may be added as necessary. Cu content is preferably at least 0.05% to obtain the effect. On the other hand, Cu content over 0.50% produces no further improvement in effectiveness, while making instead the steel sheet more susceptible to surface defect resulting from Cu and, therefore, Cu content is 0.50% or less.

Ni≦0.50%

Nickel (Ni) is an element which also contributes to enhancing the strength of the steel sheet, similarly to Cu, through solid solution strengthening and also by improving quench hardenability and generating the second phase. Further, Ni produces an effect of suppressing the surface defect resulting from Cu when added together with Cu and, thus, may be added as necessary. Ni content is preferably at least 0.05% to obtain these effects. On the other hand, Ni content over 0.50% produces no further improvement in effectiveness and, therefore, Ni content is 0.50% or less.

B≦0.0030%

Boron (B) is an element which contributes to enhancing the strength of the steel sheet by improving quench hardenability and generating the second phase, and may be added as necessary. B content is preferably at least 0.0005% to obtain the effect. On the other hand, B content over 0.0030% saturates the effect and, thus, B content is 0.0030% or less.

At least one selected from Ca (0.001%≦Ca≦0.005%) and REM (0.001%≦REM≦0.005%)

Calcium (Ca) and rare earth metal (REM) each are an element which spheroidizes the shape of a sulfide to contribute to preventing the sulfide from negatively affecting hole expansion formability, and may be added as necessary. Ca and REM each may preferably be added to at least 0.001% to obtain these effects. On the other hand, the content over 0.005% saturates the effects and, thus, the content is 0.005% or less.

In addition to the aforementioned chemical components, the balance includes Fe and incidental impurities.

Examples of the incidental impurities may include antimony (Sb), tin (Sn), and cobalt (Co), which may be added to 0.01% or less for Sb, 0.1% or less for Sn, 0.01% or less for zinc (Zn), and 0.1% or less for Co, without falling out of the allowable ranges. Further, tantalum (Ta), magnesium (Mg), and zirconium (Zr) may also be contained within the usual range of steel composition, without impairing the desired effects.

Next, the microstructure of the hot-dip galvanized steel sheet is described in detail.

It is essential that the microstructure is a complex phase which contains: ferrite having an average grain size of 15 μm or less to at least 90% in volume fraction; martensite having an average grain size of 3.0 μm or less to 0.5% or more and less than 5.0% in volume fraction; pearlite to 5.0% or less in volume fraction; and the balance being a phase generated at low temperature. The volume fraction herein refers to a volume fraction with respect to the entire microstructure of the steel sheet, and the same applies hereinafter.

First, when the volume fraction of ferrite is less than 90%, the first ferrite phase is reduced and the hard second phase is increased, with the result that a large difference in hardness is observed at many points between the second phase and the soft ferrite, and the hole expansion formability is impaired. Therefore, the volume fraction of ferrite is at least 90%, and preferably at least 92%. Further, when the ferrite has the average grain size of larger than 15 μm, voids are easily formed on a punched end surface in the hole expansion process. Hence, excellent hole expansion formability cannot be obtained. For this reason, the average grain size of ferrite is 15 μm or less. In particular, when a value obtained by dividing the volume fraction of ferrite having a grain size of 5 μm or less by the volume fraction of the entire ferrite is 0.25 or more, it is possible to suppress voids from being connected to one another along the crystal grains in a hole expansion test. Therefore, a value obtained by dividing the volume fraction of ferrite having a grain size of 5 μm or less by the volume fraction of the entire ferrite in the microstructure of the steel sheet is preferably at least 0.25.

It should be noted that the “ferrite” herein refers to any type of ferrite including recrystallized ferrite and unrecrystallized ferrite.

Next, when the volume fraction of martensite is smaller than 0.5%, there is produced only a small effect of enhancing the strength and elongation property deteriorates due to aging. Therefore, the volume fraction of martensite is at least 0.5%. On the other hand, when the volume fraction of martensite is 5.0% or more, mobile dislocations are generated by the hard martensite in the ferrite surrounding therearound, which reduces yield ratio and deteriorates hole expansion formability. For this reason, the volume fraction of martensite is less than 5.0%, and preferably 3.5% or less. Meanwhile, the average grain size of martensite over 3.0 μm increases the area of each void to be generated on a punched end surface in the hole expansion process, with the result that the voids are easily connected to one another during the hole expansion test. Hence, excellent hole expansion formability cannot be obtained. Therefore, the average grain size of martensite is 3.0 μm or less.

Further, the volume fraction of pearlite exceeding 5.0% causes significant generation of voids at an interface between ferrite and pearlite and the voids are likely to be connected to one another. Therefore, in view of workability, the volume fraction of pearlite is 5.0% or less. Although the lower limit of the volume fraction of pearlite is not specifically limited, the volume fraction of pearlite may preferably be 0.5% or more because the presence of pearlite has an effect of increasing the yield ratio and also enhancing the strength of the steel sheet.

The microstructure may also include other structures than ferrite, martensite, and pearlite described above. The balance in this case may be a type of a phase formed at low temperature selected from bainite, retained austenite, and spherodized cementite, or may be a mixed structure including a combination of two or more of the phases. The balance structure other than ferrite, martensite, and pearlite is preferred to be less than 5.0% in total in volume fraction in terms of formability and, therefore, it is needless to say that the aforementioned balance structure may be 0 volume %.

The aforementioned microstructure can be obtained through manufacturing under the following conditions by using chemical compositions satisfying the aforementioned ranges.

Further, the hot-dip galvanized steel sheet may preferably contain Nb-based precipitates having an average grain size of 0.10 μm or less. Strains around Nb-based precipitates with an average grain size of 0.10 μm or less effectively serve as obstacles to the dislocation movement, which contributes to enhancing the strength of steel.

Further, the hot-dip galvanizing layer may preferably be formed as a galvanizing layer on a surface of the steel sheet with a coating amount of 20 to 120 g/m² per one surface. The reason is that the coating amount of less than 20 g/m² may make it difficult to ensure corrosion resistance, whereas the coating amount over 120 g/m² may leads to deterioration in resistance to coating exfoliation.

Next, a method of manufacturing the hot-dip galvanized steel sheet is described.

The hot-dip galvanized steel sheet can be manufactured by a method including: preparing a steel slab having the chemical composition satisfying the aforementioned ranges; hot rolling the steel slab under conditions with a hot-rolling start temperature of 1,150° C. to 1,270° C. and a finish rolling completing temperature of 830° C. to 950° C. to be formed into a hot rolled steel sheet, which is cooled and then coiled at a coiling temperature of 450° C. to 650° C.; which is pickled and then cold rolled to be formed into a cold rolled steel sheet; heating thereafter the cold rolled steel sheet at an average heating rate of at least 5° C./s to 650° C. or above; holding the heated steel sheet at 730° C. to 880° C. for 15 seconds to 600 seconds; subsequently cooling the held steel sheet at an average cooling rate of 3° C./s to 30° C./s to a temperature of 600° C. or below; subjecting thereafter the cooled steel sheet to hot-dip galvanizing process to be formed into a hot-dip galvanized steel sheet; and cooling the hot-dip galvanized steel sheet to a room temperature.

In the aforementioned manufacturing process, a cold rolled steel sheet is used as a base steel sheet. However, the steel sheet subjected to the above-mentioned hot rolling and pickling may also be used as the base steel sheet. The manufacturing process is similarly performed as in the case of using the cold rolled steel sheet, in which the steel sheet is heated, after pickling, at an average heating rate of at least 5° C./s to be 650° C. or above, held at 730° C. to 880° C. for 15 seconds to 600 seconds, then cooled at the average cooling rate of 3° C./s to 30° C./s to 600° C. or below, and subjected thereafter to hot-dip galvanizing process and cooled to the room temperature.

According to the method of manufacturing the hot-dip galvanized steel sheet with high yield ratio, the hot-dip galvanized steel sheet may further be subjected to galvannealing process at 450° C. to 600° C.

Further, in the hot rolling step, the cast steel slab may preferably be subjected to hot rolling at 1,150° C. to 1,270° C. without being reheated or after being reheated at 1,150° C. to 1,270° C. Although the steel slab to be used is preferably manufactured through continuous casting to prevent macrosegregation of the components, the steel slab may also be manufactured through ingot casting or thin slab casting. The hot rolling step is preferably performed under a condition where the steel slab is first subjected to hot rolling at a hot-rolling start temperature of 1,150° C. to 1,270° C. In addition to a conventional method in which a steel slab once cooled to a room temperature after being casted is reheated, there may also be employed, without any problem, energy-saving processes such as hot charge rolling and hot direct rolling where a warm slab is directly charged into a heating furnace without being cooled, a heat-retained steel slab is immediately hot rolled, or a cast hot slab is directly hot rolled.

In the following, each of the manufacturing steps is described in detail.

### Hot Rolling Step

### Hot-Rolling Start Temperature: 1,150° C. to 1,270° C.

Hot-rolling start temperature is preferably 1,150° C. to 1,270° C., because the temperature falling below 1,150° C. leads to a deterioration of productivity by an increase in rolling load, while the temperature exceeding 1,270° C. results in mere increase in the heating cost.

### Finish Rolling Completing Temperature: 830° C. to 950° C.

The finish rolling completing temperature is at least 830° C. because the hot rolling needs to be completed in the austenite single phase region to attain uniformity in structure in the steel sheet and to reduce anisotropy in the material quality to improve the elongation property and hole expansion formability after annealing. However, when the finish rolling completing temperature exceeds 950° C., there is a fear that the hot rolled structure is coarsened and properties after annealing are deteriorated. Therefore, the finish rolling completing temperature is 830° C. to 950° C. Although the cooling condition after finish rolling is not specifically limited, the steel sheet may preferably be cooled to a coiling temperature at an average cooling rate of 15° C./s or more.

### Coiling Temperature: 450° C. to 650° C.

The upper limit of the coiling temperature is 650° C. because the coiling temperature over 650° C. causes precipitates such as alloy carbides generated in the cooling process after hot rolling to be significantly coarsened, which leads to deterioration in strength after annealing. The coiling temperature is preferably 600° C. or lower. On the other hand, when the coiling temperature is lower than 450° C., hard bainite and martensite are excessively generated, which increases load in the cold rolling and hinders productivity. Therefore, the lower limit of the coiling temperature is 450° C.

### Pickling Step

The pickling step may preferably be performed after hot rolling step to remove scales on the surface layer of the hot rolled steel sheet. The pickling step is not specifically limited, and may be performed by following a conventional method.

### Cold Rolling Step

The hot rolled steel sheet thus pickled is then subjected to cold rolling to be rolled into a cold rolled steel sheet having a predetermined sheet thickness as necessary. Although the cold rolling condition is not specifically limited, the cold rolling is preferably performed under a reduction ratio of at least 30%. A reduction ratio lower than 30% may fail to promote recrystallization of ferrite, with the result that unrecrystallized ferrite excessively remains, which may deteriorate the ductility and the hole expansion formability.

### Annealing

The hot rolled and pickled steel sheet or cold rolled steel sheet is subjected to annealing.

Heating condition of annealing: The steel sheet is heated at an average heating rate of 5° C./s or more to a temperature range of 650° C. or higher.

When the steel sheet is heated to below 650° C. or the average heating rate is lower than 5° C./s, uniformly dispersed fine austenite phase cannot be formed during annealing, and structures including locally concentrated second phases are formed in the final structure so that excellent hole expansion formability is hard to ensure. Meanwhile, when the average heating rate is lower than 5° C./s, the steel sheet needs to be placed in a furnace longer than normal, which leads to an increase in cost associated with greater energy consumption, and causes deterioration in production efficiency.

Soaking condition of annealing: The steel sheet is held in a temperature range of 730° C. to 880° C. for 15 seconds to 600 seconds.

The steel sheet is held (annealed) at 730° C. to 880° C., specifically, in the austenite single phase region or in the ferrite-austenite dual phase region, for 15 seconds to 600 seconds. The annealing temperature lower than 730° C., or the holding (annealing) time shorter than 15 seconds fails to sufficiently develop the recrystallization of ferrite, with the result that unrecrystallized ferrite excessively remains in the steel sheet structure, which deteriorates formability. On the other hand, the annealing temperature higher than 880° C. causes the precipitates to be coarsened, which reduces the strength. The holding time exceeding 600 seconds results in coarsening of ferrite, which impairs hole expansion formability. Thus, the soaking time is 600 seconds or shorter, and preferably 450 seconds or shorter.

Cooling condition in annealing: The steel sheet is cooled at an average cooling rate of 3° C./s to 30° C./s to a temperature range of 600° C. or lower.

After the above-mentioned soaking, the steel sheet needs to be cooled from the soaking temperature to (cooling stop temperature) 600° C. or below at an average cooling rate of 3° C./s to 30° C./s. When the average cooling rate is lower than 3° C./s, ferrite transformation develops during the cooling, which reduces the volume fraction of martensite, making it difficult to ensure strength. On the other hand, the average cooling rate exceeding 30° C./s results in excessive martensite formation, and at the same, such a high cooling rate is difficult to be attained from the facility aspect. Meanwhile, the cooling stop temperature above 600° C. results in excessive pearlite formation, which fails to attain a predetermined volume fraction in the microstructure of the steel sheet, with the result that the ductility and the hole expansion formability are deteriorated.

It should be noted that the above-mentioned average cooling rate is applied to 600° C. or below to a temperature of a hot-dip galvanizing bath (molten bath of zinc), and the average cooling rate of 3° C./s to 30° C./s needs to be retained in this temperature range.

### Hot-Dip Galvanizing Process

The steel sheet is subjected to hot-dip galvanizing after annealing. The steel sheet temperature to be immersed in the molten bath is preferably (the temperature of the hot-dip galvanizing bath −40)° C. to (the temperature of the hot-dip galvanizing bath +50)° C. When the temperature of the steel sheet to be immersed in the molten bath falls below (the temperature of the hot-dip galvanizing bath −40)° C., part of the molten zinc is solidified when the steel sheet is immersed in the molten bath which may deteriorate the surface appearance of the coating and, thus, the lower limit is (the temperature of the hot-dip galvanizing bath −40)° C. Meanwhile, when the temperature of the steel sheet to be immersed in the molten bath exceeds (the temperature of the hot-dip galvanizing bath +50)° C., there arises a problem in terms of mass productivity because the temperature of the molten bath is increased.

After the galvanizing process, the steel sheet may be subjected to galvannealing process at 450° C. to 600° C. The steel sheet thus galvannealed at 450° C. to 600° C. has Fe concentration of 7% to 15% in the coating, which improves the coating adhesion property and corrosion resistance property after painting. A temperature lower than 450° C. fails to sufficiently develop the galvannealing, which leads to a reduction in sacrificial corrosion protection ability and a reduction in slidability. The temperature higher than 600° C. causes significant development of galvannealing, which impairs powdering resistance.

Although other manufacturing conditions are not particularly limited, the above-mentioned series of processes including annealing, hot-dip galvanizing, and galvannealing process may preferably be performed in a continuous galvanizing line (CGL) in the light of productivity. Further, in the hot-dip galvanizing, a galvanizing bath including Al amount of 0.10 to 0.20% may preferably be used. After the galvanizing process, the steel sheet may be subjected to wiping to adjust the coating weight.

### EXAMPLES

In the following, Examples of our steel sheets and methods are described. However, this disclosure is no way limited by Examples below, and may be subjected to appropriate modifications without departing from the spirit of this disclosure, which are all within the technical scope of the text herein.

Steel samples having the chemical compositions shown in Table 1 were prepared by steel making and casted to manufacture slabs each being 230 mm in thickness. The slabs thus manufactured were subjected to hot rolling under the conditions of the hot-rolling start temperature and of the finish rolling completing temperature (finisher delivery temperature (FDT)) shown in Table 2, which were then cooled after the hot rolling to be formed into hot rolled steel sheets each being 3.2 mm in sheet thickness. The steel sheets thus obtained were coiled at the coiling temperatures (CT) shown in Table 2. Then, the hot rolled steel sheets thus obtained were subjected to pickling, and then to cold rolling under the conditions shown in Table 2, to be formed into cold rolled steel sheets. The cold rolled steel sheets thus obtained were subjected to annealing process in a continuous galvanizing line under the processing conditions shown in Table 2, and subjected to hot-dip galvanizing process, which were then galvannealed at the temperatures shown in Table 2, to thereby obtain hot-dip galvannealed steel sheets. Some of the steel sheets were exempted from the cold rolling to serve as the base steel sheets as hot rolled and pickled. Further, as shown in Table 2, some of the steel sheets were exempted from the galvannealing process.

The galvanizing process was performed under the following conditions: the galvanizing bath temperature: 460° C.; Al concentration in the galvanizing bath: 0.14 mass % (for performing galvannealing process) or 0.18 mass % (for not performing galvannealing process); and the coating amount per one surface: 45 g/m² (two-side coating).

JIS No. 5 tensile test specimens each having a longitudinal direction (tensile direction) in a direction transverse to the rolling direction were collected from the coated steel sheets thus manufactured, and the specimens were subjected to tensile test in accordance with JIS Z2241 (1998) to measure the yield strength (YS), the tensile strength (TS), the total elongation (EL), and the yield ratio (YR). A steel sheet with the EL of 26.5% or more was evaluated as having excellent elongation, and a steel sheet with the YR of 70% or more was evaluated as having high yield ratio. To evaluate the aging effect, the specimens which had been left for 10 days at 70° C. were subjected to tensile test to measure the EL, and the difference ΔEL compared to the EL of a freshly-manufactured steel sheet yet to be left for aging was calculated. When ΔEL≦1.0%, it was determined that the EL was less deteriorated after aging. Aging of 10 days at 70° C. corresponds to the aging of 6 months at 38° C. according to the Hundy's report (Metallurgia, vol. 52, p. 203 (1956)).

Hole expansion formability was determined in accordance with the Japan Iron and Steel Federation Standard (JFS T1001 (1996)). The specimens were each punched a hole of 10 mmφ with a clearance of 12.5% and set to a test machine with burr facing on the die side. Then, a 60° conical punch was pressed into the hole for shaping, to thereby measure the hole expansion ratio (λ). A steel sheet having λ(%) of 60% or more was determined as having good stretch flangeability.

To evaluate the microstructure of each of the steel sheets, 3% nital reagent (3% nitric acid+ethanol) was used to etch a vertical section (at the ¼ depth position of the sheet thickness) parallel to the rolling direction of the steel sheet, and the etched section was observed and a micrograph thereof was obtained with the use of an optical microscope of 500 to 1,000 magnifications and of a (scanning or transmission) electron microscope of 1,000 to 10,000 magnifications. Based on the micrograph thus obtained, the volume fraction and the average crystal grain size of ferrite, the volume fraction and the average crystal grain size of martensite, and the volume fraction of pearlite were quantified. Each phase was observed with a field number of 12 to obtain the area fraction by the point counting method (in accordance with ASTM E562-83 (1988)), and the area fraction thus obtained was taken as the volume fraction of the phase.

Ferrite phase can be observed as a blackish contrast region, while pearlite can be observed as a layered structure in which a sheet-like ferrite and cementite are alternately arranged. Martensite was observed as a whitish contrast region. As to the phases formed at low temperature as the balance, pearlite and bainite can be discriminated from each other in the aforementioned optical microscopic observation or (scanning or transmission) electron microscopic observation, in which pearlite can be observed as a layered structure having a sheet-like ferrite and cementite being alternately arranged while bainite forms a microstructure including cementite and a sheet-like bainitic-ferrite, which is higher in dislocation density as compared to polygonal ferrite. Meanwhile, the presence or absence of retained austenite was determined as follows. The steel sheet surface was polished to the depth of ¼ of the sheet thickness from the surface layer, and the surface was analyzed by X-ray diffraction method (with a RINT-2200 diffractometer manufactured by Rigaku Corporation) with MoKa radiation as a radiation source at an acceleration voltage of 50 keV to measure the integrated intensity of X-ray diffraction line for each of {200} plane, {211} plane, and the {220} plane of ferrite of Fe and for {200} plane, {220} plane, and {311} plane of austenite of Fe. Based on the measured values thus obtained, the volume fraction of retained austenite was determined using the formula described in “A Handbook of X-Ray Diffraction” (Rigaku Corporation, 2000, pp. 26, 62 to 64). When the volume fraction was 1% or more, retained austenite is deemed to be present, while retained austenite is deemed to be absent when the volume fraction is less than 1%.

The average grain size of each of the Nb-based precipitates (carbides) was measured as follows. A thin film manufactured from the obtained steel sheet was observed by a transmission electron microscope (TEM) with a field number of 10 (at magnifications of 500,000 in an enlarged micrograph) to obtain the average grain size of each precipitated carbides. The grain size of each carbide was defined in the following manner. That is, when the carbide is in a spherical shape, the diameter thereof was defined as the grain size. When the carbide is in an elliptical shape, the long axis a of the carbide and the short axis perpendicular to the long axis were measured, and the square root of the product a×b of the long axis a and the short axis b was defined as the grain size. A value obtained by adding the grain sizes of the respective carbides observed with a field number of 10 was divided by the number of the carbides, to thereby obtain the average grain size of the carbides.

Table 3 shows the microstructure, the tensile properties, and the hole expansion formability measured for each steel sheet. It can be appreciated from the results shown in Table 3 that Examples satisfying the requirements all have the volume fraction of at least 90% for ferrite having an average crystal grain size of 15 μm or less, the volume fraction of 0.5% or more and less than 5.0% for martensite having an average crystal grain size of 3.0 μm or less, and the volume fraction of 5.0% or less for pearlite, with the result that Examples are all excellent in formability as having the total elongation of at least 26.5%, the hole expansion ratio of at least 60%, with less deterioration in total elongation after aging, while ensuring the tensile strength of at least 590 MPa and the yield ratio of at least 70%.

TABLE 1

| Steel | | | | | | | | | | |
|---|---|---|---|---|---|---|---|---|---|---|
| Sample | Chemical Composition (mass %) | | | | | | | | | |
| ID | C | Si | Mn | P | S | Al | N | Nb | Other Components | Remarks |
| A | 0.11 | 0.71 | 1.40 | 0.01 | 0.003 | 0.03 | 0.003 | 0.034 | — | Conforming Steel |
| B | 0.09 | 0.45 | 1.55 | 0.02 | 0.003 | 0.03 | 0.003 | 0.035 | — | Conforming Steel |
| C | 0.07 | 0.28 | 1.82 | 0.02 | 0.002 | 0.03 | 0.002 | 0.025 | — | Conforming Steel |
| D | 0.10 | 0.40 | 1.48 | 0.01 | 0.003 | 0.03 | 0.003 | 0.032 | Ti: 0.02 | Conforming Steel |
| E | 0.10 | 0.25 | 1.65 | 0.02 | 0.003 | 0.03 | 0.003 | 0.024 | V: 0.02 | Conforming Steel |
| F | 0.07 | 0.64 | 1.40 | 0.01 | 0.004 | 0.03 | 0.003 | 0.033 | Cr: 0.20 | Conforming Steel |
| G | 0.11 | 0.51 | 1.44 | 0.01 | 0.003 | 0.04 | 0.003 | 0.029 | Mo: 0.20 | Conforming Steel |
| H | 0.09 | 0.78 | 1.55 | 0.01 | 0.003 | 0.03 | 0.003 | 0.025 | Cu: 0.10 | Conforming Steel |
| I | 0.10 | 0.68 | 1.48 | 0.01 | 0.003 | 0.03 | 0.003 | 0.025 | Ni: 0.10 | Conforming Steel |
| J | 0.12 | 0.39 | 1.28 | 0.01 | 0.003 | 0.03 | 0.003 | 0.039 | B: 0.0015 | Conforming Steel |
| K | 0.10 | 0.38 | 1.32 | 0.01 | 0.003 | 0.03 | 0.003 | 0.050 | Ca: 0.001, REM: 0.002 | Conforming Steel |
| L | 0.11 | 0.05 | 1.88 | 0.01 | 0.003 | 0.04 | 0.002 | 0.035 | — | Comparative Steel |
| M | 0.11 | 0.56 | 0.88 | 0.01 | 0.003 | 0.03 | 0.003 | 0.033 | — | Comparative Steel |
| N | 0.08 | 0.33 | 2.03 | 0.01 | 0.003 | 0.03 | 0.003 | 0.029 | — | Comparative Steel |
| O | 0.09 | 0.43 | 1.78 | 0.01 | 0.003 | 0.03 | 0.003 | 0.005 | — | Comparative Steel |
| P | 0.04 | 0.78 | 1.68 | 0.01 | 0.003 | 0.03 | 0.003 | 0.038 | — | Comparative Steel |
| Q | 0.18 | 0.54 | 1.80 | 0.02 | 0.003 | 0.03 | 0.003 | 0.024 | — | Comparative Steel |
| R | 0.12 | 1.10 | 1.18 | 0.01 | 0.003 | 0.03 | 0.002 | 0.021 | — | Comparative Steel |
| S | 0.07 | 0.59 | 1.33 | 0.01 | 0.003 | 0.03 | 0.003 | 0.115 | — | Comparative Steel |

Underlined value: out of the range of our steel sheets and methods

TABLE 2

| | | Hot Rolling Conditions | | | Cold Rolling | Annealing Conditions | |
|---|---|---|---|---|---|---|---|
| Galvanized | | Rolling | | | Condition | Average | |
| Steel | Steel | Start | | | Reduction | Heating | Heating |
| Sheet | Sample | TemperAture | FDT | CT | Ratio | Rate | TemperAture |
| No. | ID | ° C. | ° C. | ° C. | % | ° C./s | ° C. |
| 1 | A | 1230 | 900 | 600 | 50 | 10 | 750 |
| 2 | A | 1200 | 900 | 520 | 50 | 3 | 750 |
| 3 | A | 1200 | 930 | 580 | 50 | 10 | 600 |
| 4 | A | 1200 | 900 | 580 | 40 | 15 | 650 |
| 5 | A | 1200 | 900 | 580 | 40 | 10 | 800 |
| 6 | B | 1200 | 900 | 580 | 40 | 10 | 750 |
| 7 | B | 1200 | 900 | 580 | 50 | 10 | 750 |
| 8 | B | 1200 | 900 | 580 | 50 | 10 | 750 |
| 9 | B | 1200 | 900 | 580 | 50 | 7 | 750 |
| 10 | B | 1200 | 890 | 580 | 60 | 10 | 750 |
| 11 | B | 1200 | 850 | 450 | 60 | 10 | 750 |
| 12 | B | 1270 | 900 | 500 | 40 | 10 | 750 |
| 13 | B | 1200 | 900 | 700 | 40 | 12 | 750 |
| 14 | B | 1200 | 900 | 500 | 40 | 20 | 800 |
| 15 | B | 1200 | 1000 | 600 | 40 | 10 | 750 |
| 16 | B | 1200 | 800 | 600 | 50 | 10 | 750 |
| 17 | C | 1200 | 900 | 600 | 50 | 10 | 750 |
| 18 | C | 1200 | 900 | 580 | 50 | 10 | 700 |
| 19 | C | 1200 | 900 | 580 | 50 | 10 | 700 |
| 20 | D | 1200 | 900 | 580 | 50 | 8 | 750 |
| 21 | D | 1200 | 900 | 520 | 50 | 15 | 750 |
| 22 | D | 1200 | 900 | 580 | 50 | 10 | 750 |
| 23 | E | 1150 | 900 | 580 | 50 | 10 | 750 |
| 24 | F | 1200 | 900 | 550 | 50 | 10 | 750 |
| 25 | G | 1200 | 880 | 600 | 50 | 10 | 750 |
| 26 | H | 1200 | 920 | 500 | 50 | 10 | 750 |
| 27 | I | 1200 | 900 | 600 | 60 | 10 | 750 |
| 28 | J | 1230 | 900 | 620 | 50 | 10 | 750 |
| 29 | K | 1250 | 900 | 600 | 50 | 10 | 750 |
| 30 | L | 1230 | 900 | 600 | 40 | 10 | 750 |
| 31 | M | 1200 | 900 | 620 | 50 | 10 | 750 |
| 32 | N | 1230 | 880 | 600 | 50 | 10 | 750 |
| 33 | O | 1230 | 900 | 600 | 50 | 10 | 750 |
| 34 | P | 1230 | 900 | 600 | 50 | 10 | 750 |
| 35 | Q | 1230 | 900 | 600 | 50 | 10 | 750 |
| 36 | R | 1200 | 900 | 600 | 50 | 10 | 750 |
| 37 | S | 1230 | 900 | 580 | 50 | 10 | 750 |
| 38 | A | 1230 | 900 | 580 | — | 10 | 750 |
| 39 | B | 1200 | 900 | 580 | — | 10 | 750 |
| 40 | C | 1200 | 900 | 580 | — | 10 | 750 |

| | Annealing Conditions | | | | | |
|---|---|---|---|---|---|---|
| Galvanized | | | Average | Cooling | Galvannealing | |
| Steel | Soaking | Soaking | Cooling | Stop | Treatment | |
| Sheet | Temperature | Time | Rate | Temperature | Temperature | |
| No. | ° C. | s | ° C./s | ° C. | ° C. | Remarks |
| 1 | 825 | 120 | 10 | 525 | 525 | Example |
| 2 | 825 | 120 | 10 | 525 | 525 | Comparative |
| | | | | | | Example |
| 3 | 800 | 120 | 10 | 525 | 525 | Comparative |
| | | | | | | Example |
| 4 | 710 | 150 | 15 | 525 | 525 | Comparative |
| | | | | | | Example |
| 5 | 920 | 90 | 10 | 525 | 525 | Comparative |
| | | | | | | Example |
| 6 | 825 | 120 | 12 | 525 | 525 | Example |
| 7 | 825 | 10 | 10 | 525 | 525 | Comparative |
| | | | | | | Example |
| 8 | 825 | 120 | 1 | 525 | 525 | Comparative |
| | | | | | | Example |
| 9 | 780 | 450 | 5 | 525 | 525 | Example |
| 10 | 825 | 150 | 10 | 525 | — | Example |
| 11 | 880 | 120 | 25 | 525 | — | Example |
| 12 | 800 | 90 | 10 | 525 | 600 | Example |
| 13 | 850 | 400 | 10 | 525 | 525 | Comparative |
| | | | | | | Example |
| 14 | 860 | 300 | 5 | 525 | 525 | Example |
| 15 | 850 | 150 | 10 | 525 | 525 | Comparative |
| | | | | | | Example |
| 16 | 850 | 150 | 10 | 525 | 525 | Comparative |
| | | | | | | Example |
| 17 | 825 | 150 | 50 | 525 | 525 | Comparative |
| | | | | | | Example |
| 18 | 750 | 300 | 10 | 525 | 525 | Example |
| 19 | 800 | 150 | 15 | 650 | 525 | Comparative |
| | | | | | | Example |
| 20 | 850 | 500 | 25 | 525 | 525 | Example |
| 21 | 800 | 120 | 10 | 525 | 525 | Example |
| 22 | 850 | 120 | 10 | 525 | — | Example |
| 23 | 825 | 120 | 10 | 525 | 525 | Example |
| 24 | 825 | 120 | 10 | 525 | 525 | Example |
| 25 | 825 | 120 | 10 | 525 | 525 | Example |
| 26 | 850 | 120 | 10 | 525 | 525 | Example |
| 27 | 825 | 120 | 10 | 525 | 525 | Example |
| 28 | 870 | 200 | 15 | 525 | 525 | Example |
| 29 | 850 | 120 | 10 | 525 | 525 | Example |
| 30 | 825 | 120 | 10 | 525 | 525 | Comparative |
| | | | | | | Example |
| 31 | 850 | 120 | 10 | 525 | 525 | Comparative |
| | | | | | | Example |
| 32 | 825 | 120 | 10 | 525 | 525 | Comparative |
| | | | | | | Example |
| 33 | 800 | 120 | 10 | 525 | 525 | Comparative |
| | | | | | | Example |
| 34 | 800 | 120 | 10 | 525 | 525 | Comparative |
| | | | | | | Example |
| 35 | 850 | 120 | 10 | 525 | 525 | Comparative |
| | | | | | | Example |
| 36 | 800 | 200 | 10 | 525 | 525 | Comparative |
| | | | | | | Example |
| 37 | 825 | 150 | 20 | 525 | 525 | Comparative |
| | | | | | | Example |
| 38 | 825 | 120 | 15 | 525 | 525 | Example |
| 39 | 825 | 120 | 15 | 525 | 550 | Example |
| 40 | 800 | 120 | 20 | 525 | 525 | Example |

Underlined value: out of the range of our steel sheets and methods

TABLE 3

| | Steel Sheet Microstructure | | | | | | |
|---|---|---|---|---|---|---|---|
| | Ferrite | | | | | | |
| | | | Ratio of | | | | |
| | | | Ferrite | | | | |
| | | | having | | | | |
| | | | grain | | | | |
| | | | size of | Martensite | | | |
| Galvanized | | Average | 5 μm or | | Average | | |
| Steel | | Grain | less in | | Grain | Pearlite | |
| Sheet | Volume | Size/ | total | Volume | Size/ | Volume | The |
| No. | Fraction/% | μm | Ferrite | Fraction/% | μm | Fraction/% | Balance |
| 1 | 94 | 10 | 0.33 | 3.2 | 2.5 | 2.8 | — |
| 2 | 92 | 9 | 0.26 | 3.5 | 3.3 | 3.8 | SC |
| 3 | 95 | 8 | 0.22 | 2.1 | 3.1 | 2.9 | — |
| 4 | 89 | 7 | 0.65 | 5.7 | 2.3 | 2.0 | RA, B |
| 5 | 92 | 13 | 0.19 | 2.1 | 2.8 | 5.8 | SC |
| 6 | 93 | 8 | 0.35 | 2.5 | 1.8 | 3.1 | B |
| 7 | 86 | 6 | 0.68 | 8.8 | 1.9 | 1.8 | SC |
| 8 | 96 | 18 | 0.18 | 0.2 | 1.8 | 3.3 | SC |
| 9 | 93 | 12 | 0.28 | 3.1 | 1.7 | 3.1 | SC |
| 10 | 93 | 10 | 0.30 | 2.3 | 2.1 | 2.3 | RA, B |
| 11 | 94 | 8 | 0.33 | 4.3 | 2.5 | 0.5 | B |
| 12 | 93 | 10 | 0.28 | 0.6 | 1.8 | 4.8 | B |
| 13 | 94 | 20 | 0.11 | 2.3 | 2.5 | 2.3 | B |
| 14 | 92 | 11 | 0.28 | 2.1 | 1.9 | 4.3 | SC |
| 15 | 98 | 22 | 0.13 | 0.8 | 2.0 | 1.0 | SC |
| 16 | 95 | 16 | 0.24 | 1.3 | 1.8 | 3.3 | SC |
| 17 | 90 | 10 | 0.38 | 7.8 | 2.5 | 1.3 | B |
| 18 | 93 | 9 | 0.39 | 3.3 | 2.5 | 2.1 | B |
| 19 | 91 | 8 | 0.41 | — | — | 7.1 | SC |
| 20 | 92 | 14 | 0.26 | 4.3 | 1.8 | 3.4 | B |
| 21 | 93 | 8 | 0.43 | 2.9 | 2.3 | 1.8 | B, SC |
| 22 | 91 | 8 | 0.41 | 2.4 | 1.8 | 2.8 | B, RA, SC |
| 23 | 93 | 8 | 0.33 | 3.2 | 2.3 | 2.1 | SC |
| 24 | 92 | 7 | 0.38 | 4.8 | 1.8 | 0.5 | B, RA |
| 25 | 91 | 8 | 0.29 | 4.3 | 2.8 | 1.3 | B, RA |
| 26 | 91 | 9 | 0.26 | 3.9 | 2.1 | 1.9 | B, RA |
| 27 | 93 | 10 | 0.26 | 3.8 | 2.0 | 1.8 | B |
| 28 | 91 | 7 | 0.53 | 4.6 | 2.4 | 1.9 | B |
| 29 | 92 | 10 | 0.33 | 3.1 | 2.5 | 3.1 | SC |
| 30 | 91 | 8 | 0.35 | 7.8 | 3.3 | 1.1 | B |
| 31 | 93 | 10 | 0.25 | 1.3 | 2.3 | 5.5 | SC |
| 32 | 88 | 12 | 0.26 | 6.3 | 3.8 | 3.1 | B, RA |
| 33 | 89 | 16 | 0.31 | 3.3 | 3.4 | 3.5 | B, RA |
| 34 | 97 | 12 | 0.21 | 0.3 | 1.8 | 2.5 | SC |
| 35 | 89 | 9 | 0.33 | 6.3 | 4.5 | 4.3 | SC |
| 36 | 91 | 13 | 0.26 | 3.3 | 3.5 | 5.2 | B, RA |
| 37 | 94 | 8 | 0.45 | 2.2 | 1.9 | 3.3 | SC |
| 38 | 94 | 11 | 0.29 | 3.1 | 2.7 | 2.6 | SC |
| 39 | 93 | 8 | 0.28 | 2.6 | 2.0 | 2.9 | B |
| 40 | 93 | 9 | 0.33 | 3.2 | 2.3 | 2.0 | B |

| | Average | | | | | | | |
|---|---|---|---|---|---|---|---|---|
| | Grain | | | | | | | |
| | Size of | | | | | Hole | | |
| Galvanized | Nb- | | | | | Expansion | ΔEL | |
| Steel | based | Tensile Properties | | | | Ratio | after | |
| Sheet | Carbide | YS | TS | EL | YR | λ | aging | |
| No. | μm | MPa | MPa | % | % | % | % | Remarks |
| 1 | 0.04 | 489 | 626 | 26.8 | 78 | 65 | 0.5 | Example |
| 2 | 0.03 | 488 | 611 | 27.3 | 80 | 58 | 0.8 | Comparative |
| | | | | | | | | Example |
| 3 | 0.05 | 456 | 598 | 26.7 | 76 | 51 | 0.4 | Comparative |
| | | | | | | | | Example |
| 4 | 0.02 | 455 | 711 | 27.3 | 64 | 43 | 0.3 | Comparative |
| | | | | | | | | Example |
| 5 | 0.13 | 488 | 577 | 28.8 | 85 | 55 | 0.6 | Comparative |
| | | | | | | | | Example |
| 6 | 0.03 | 466 | 622 | 26.9 | 75 | 64 | 0.9 | Example |
| 7 | 0.04 | 413 | 631 | 29.3 | 65 | 50 | 0.2 | Comparative |
| | | | | | | | | Example |
| 8 | 0.05 | 433 | 596 | 25.9 | 73 | 59 | 2.1 | Comparative |
| | | | | | | | | Example |
| 9 | 0.03 | 452 | 628 | 28.0 | 72 | 68 | 0.7 | Example |
| 10 | 0.05 | 516 | 644 | 27.7 | 80 | 81 | 0.6 | Example |
| 11 | 0.04 | 484 | 594 | 30.8 | 81 | 94 | 0.4 | Example |
| 12 | 0.08 | 476 | 633 | 26.8 | 75 | 80 | 0.5 | Example |
| 13 | 0.15 | 443 | 578 | 26.7 | 77 | 65 | 0.3 | Comparative |
| | | | | | | | | Example |
| 14 | 0.05 | 500 | 604 | 29.9 | 83 | 76 | 0.8 | Example |
| 15 | 0.08 | 455 | 604 | 24.3 | 75 | 54 | 1.1 | Comparative |
| | | | | | | | | Example |
| 16 | 0.05 | 465 | 595 | 25.1 | 78 | 61 | 1.5 | Comparative |
| | | | | | | | | Example |
| 17 | 0.03 | 413 | 633 | 27.8 | 65 | 50 | 0.3 | Comparative |
| | | | | | | | | Example |
| 18 | 0.04 | 544 | 663 | 26.5 | 82 | 61 | 0.4 | Example |
| 19 | 0.04 | 485 | 610 | 24.8 | 80 | 55 | 3.1 | Comparative |
| | | | | | | | | Example |
| 20 | 0.03 | 454 | 617 | 30.7 | 74 | 84 | 0.6 | Example |
| 21 | 0.04 | 469 | 630 | 28.5 | 74 | 72 | 0.7 | Example |
| 22 | 0.06 | 477 | 608 | 26.9 | 78 | 63 | 0.7 | Example |
| 23 | 0.03 | 453 | 601 | 26.7 | 75 | 69 | 0.8 | Example |
| 24 | 0.05 | 455 | 599 | 28.8 | 76 | 65 | 0.7 | Example |
| 25 | 0.04 | 465 | 613 | 28.9 | 76 | 70 | 0.6 | Example |
| 26 | 0.05 | 468 | 633 | 27.3 | 74 | 69 | 0.8 | Example |
| 27 | 0.04 | 456 | 634 | 28.1 | 72 | 63 | 0.9 | Example |
| 28 | 0.04 | 513 | 651 | 26.7 | 79 | 69 | 0.3 | Example |
| 29 | 0.03 | 465 | 603 | 27.2 | 77 | 65 | 0.3 | Example |
| 30 | 0.03 | 413 | 609 | 30.3 | 68 | 54 | 0.2 | Comparative |
| | | | | | | | | Example |
| 31 | 0.05 | 433 | 611 | 27.3 | 71 | 48 | 0.5 | Comparative |
| | | | | | | | | Example |
| 32 | 0.08 | 410 | 633 | 29.8 | 65 | 56 | 0.5 | Comparative |
| | | | | | | | | Example |
| 33 | 0.01 | 393 | 586 | 28.9 | 67 | 50 | 0.4 | Comparative |
| | | | | | | | | Example |
| 34 | 0.02 | 423 | 545 | 30.1 | 78 | 61 | 2.9 | Comparative |
| | | | | | | | | Example |
| 35 | 0.03 | 388 | 591 | 29.1 | 66 | 44 | 0.3 | Comparative |
| | | | | | | | | Example |
| 36 | 0.05 | 422 | 621 | 26.8 | 68 | 43 | 0.9 | Comparative |
| | | | | | | | | Example |
| 37 | 0.11 | 488 | 622 | 22.9 | 78 | 65 | 0.8 | Comparative |
| | | | | | | | | Example |
| 38 | 0.02 | 478 | 626 | 26.9 | 76 | 61 | 0.6 | Example |
| 39 | 0.02 | 459 | 622 | 27.5 | 74 | 66 | 0.7 | Example |
| 40 | 0.02 | 513 | 643 | 26.8 | 80 | 63 | 0.5 | Example |

Underlined Value: Out of the range of our steel sheets and methods
RA: Retained Austenite,
B: Bainite.
SC: Spherodized Cementite

1-10. (canceled)

11. A hot-dip galvanized steel sheet having a chemical composition containing by mass %:
C: 0.05% to 0.15%;
Si: 0.10% to 0.90%;
Mn: 1.0% to 1.9%;
P: 0.005% to 0.10%;
S: 0.0050% or less;
Al: 0.01% to 0.10%;
N: 0.0050% or less;
Nb: 0.010% to 0.100%; and
the balance including Fe and incidental impurities,
wherein the steel sheet has a complex phase that includes:
ferrite having an average crystal grain size of 15 μm or less to at least 90% in volume fraction;
martensite having an average crystal grain size of 3.0 μm or less to 0.5% or more and less than 5.0% in volume fraction; pearlite to 5.0% or less in volume fraction; and
the balance being a phase generated at low temperature, and
wherein the steel sheet has a yield ratio of at least 70% and a tensile strength of at least 590 MPa.

12. The hot-dip galvanized steel sheet according to claim 11, further contains Nb-based precipitates having an average grain diameter of 0.10 μm or less.

13. The hot-dip galvanized steel sheet according to claim 11, further comprising, by mass %, in place of part of Fe component, 0.10% or less of Ti.

14. The hot-dip galvanized steel sheet according to claim 11, wherein a value obtained by dividing a volume fraction of ferrite having a grain size of 5 μm or less in the microstructure by a volume fraction of the entire ferrite in the microstructure of the steel sheet satisfies 0.25 or more.

15. The hot-dip galvanized steel sheet according to claim 12, wherein a value obtained by dividing a volume fraction of ferrite having a grain size of 5 μm or less in the microstructure by a volume fraction of the entire ferrite in the microstructure of the steel sheet satisfies 0.25 or more.

16. The hot-dip galvanized steel sheet according to claim 13, wherein a value obtained by dividing a volume fraction of ferrite having a grain size of 5 μm or less in the microstructure by a volume fraction of the entire ferrite in the microstructure of the steel sheet satisfies 0.25 or more.

17. The hot-dip galvanized steel sheet according to claim 11, further comprising by mass %, in place of part of Fe component, at least one component selected from the following components:
V: 0.10% or less;
Cr: 0.50% or less;
Mo: 0.50% or less;
Cu: 0.50% or less;
Ni: 0.50% or less; and
B: 0.0030% or less.

18. The hot-dip galvanized steel sheet according to claim 11, further comprising by mass %, in place of part of Fe component, at least one component selected from the following components:
Ca: 0.001% to 0.005%; and
REM: 0.001% to 0.005%.

19. The hot-dip galvanized steel sheet according to claim 11, wherein the galvanized coating is galvannealed coating.

20. The hot-dip galvanized steel sheet according to claim 13, wherein the galvanized coating is galvannealed coating.

21. A method of manufacturing a hot-dip galvanized steel sheet, comprising,
preparing a steel slab having the chemical composition according to claim 11;
hot rolling the steel slab with a hot-rolling start temperature of 1,150° C. to 1,270° C. and a finish rolling completing temperature of 830° C. to 950° C. to be formed into a hot rolled steel sheet, which is cooled and then coiled at a coiling temperature of 450° C. to 650° C.; which is pickled and then cold rolled to be formed into a cold rolled steel sheet;
heating thereafter the cold rolled steel sheet at an average heating rate of at least 5° C./s to a temperature range of 650° C. or above;
holding the heated steel sheet at 730° C. to 880° C. for 15 seconds to 600 seconds;
subsequently cooling the held steel sheet at an average cooling rate of 3° C./s to 30° C./s to a temperature of 600° C. or below;
subjecting thereafter the cooled steel sheet to hot-dip galvanizing process to be formed into a hot-dip galvanized steel sheet; and
cooling the hot-dip galvanized steel sheet to a room temperature.

22. A method of manufacturing a hot-dip galvanized steel sheet, comprising,
preparing a steel slab having the chemical composition according to claim 13;
hot rolling the steel slab with a hot-rolling start temperature of 1,150° C. to 1,270° C. and a finish rolling completing temperature of 830° C. to 950° C. to be formed into a hot rolled steel sheet, which is cooled and then coiled at a coiling temperature of 450° C. to 650° C.; which is pickled and then cold rolled to be formed into a cold rolled steel sheet;
heating thereafter the cold rolled steel sheet at an average heating rate of at least 5° C./s to a temperature of 650° C. or above;
holding the heated steel sheet at 730° C. to 880° C. for 15 seconds to 600 seconds;
subsequently cooling the held steel sheet at an average cooling rate of 3° C./s to 30° C./s to a temperature of 600° C. or below;
subjecting thereafter the cooled steel sheet to hot-dip galvanizing process to be formed into a hot-dip galvanized steel sheet; and
cooling the hot-dip galvanized steel sheet to a room temperature.

23. A method of manufacturing a hot-dip galvanized steel sheet, comprising,
preparing a steel slab having the chemical composition according to claim 17;
hot rolling the steel slab under the conditions with a hot-rolling start temperature of 1,150° C. to 1,270° C. and a finish rolling completing temperature of 830° C. to 950° C. to be formed into a hot rolled steel sheet, which is cooled and then coiled at a coiling temperature of 450° C. to 650° C.; which is pickled and then cold rolled to be formed into a cold rolled steel sheet;
heating thereafter the cold rolled steel sheet at an average heating rate of at least 5° C./s to a temperature of 650° C. or above;
holding the heated steel sheet at 730° C. to 880° C. for 15 seconds to 600 seconds;
subsequently cooling the held steel sheet at an average cooling rate of 3° C./s to 30° C./s to a temperature of 600° C. or below;
subjecting thereafter the cooled steel sheet to hot-dip galvanizing process to be formed into a hot-dip galvanized steel sheet; and
cooling the hot-dip galvanized steel sheet to a room temperature.

24. A method of manufacturing a hot-dip galvanized steel sheet, comprising,
preparing a steel slab having the chemical composition according to claim 18;
hot rolling the steel slab under the conditions with a hot-rolling start temperature of 1,150° C. to 1,270° C. and a finish rolling completing temperature of 830° C. to 950° C. to be formed into a hot rolled steel sheet, which is cooled and then coiled at a coiling temperature of 450° C. to 650° C.; which is pickled and then cold rolled to be formed into a cold rolled steel sheet;
heating thereafter the cold rolled steel sheet at an average heating rate of at least 5° C./s to a temperature of 650° C. or above;
holding the heated steel sheet at 730° C. to 880° C. for 15 seconds to 600 seconds;
subsequently cooling the held steel sheet at an average cooling rate of 3° C./s to 30° C./s to a temperature of 600° C. or below;
subjecting thereafter the cooled steel sheet to hot-dip galvanizing process to be formed into a hot-dip galvanized steel sheet; and
cooling the hot-dip galvanized steel sheet to a room temperature.

25. A method of manufacturing a hot-dip galvanized steel sheet, comprising:
preparing a steel slab having the chemical composition according to claim 11;
hot rolling the steel slab under the conditions with a hot-rolling start temperature of 1,150° C. to 1,270° C. and a finish rolling completing temperature of 830° C. to 950° C. to be formed into a hot rolled steel sheet, which is cooled and then coiled at a coiling temperature of 450° C. to 650° C.; which is pickled;
heating thereafter the pickled steel sheet at an average heating rate of at least 5° C./s to a temperature of 650° C. or above;
holding the heated steel sheet at 730° C. to 880° C. for 15 seconds to 600 seconds;
subsequently cooling the held steel sheet at an average cooling rate of 3° C./s to 30° C./s to a temperature of 600° C. or below;
subjecting thereafter the cooled steel sheet to hot-dip galvanizing process to be formed into a hot-dip galvanized steel sheet; and
cooling the hot-dip galvanized steel sheet to a room temperature.

26. A method of manufacturing a hot-dip galvanized steel sheet, comprising:
preparing a steel slab having the chemical composition according to claim 13;
hot rolling the steel slab under the conditions with a hot-rolling start temperature of 1,150° C. to 1,270° C. and a finish rolling completing temperature of 830° C. to 950° C. to be formed into a hot rolled steel sheet, which is cooled and then coiled at a coiling temperature of 450° C. to 650° C.; which is pickled;
heating thereafter the pickled steel sheet at an average heating rate of at least 5° C./s to a temperature of 650° C. or above;
holding the heated steel sheet at 730° C. to 880° C. for 15 seconds to 600 seconds;
subsequently cooling the held steel sheet at an average cooling rate of 3° C./s to 30° C./s to a temperature of 600° C. or below;
subjecting thereafter the cooled steel sheet to hot-dip galvanizing process to be formed into a hot-dip galvanized steel sheet; and
cooling the hot-dip galvanized steel sheet to a room temperature.

27. A method of manufacturing a hot-dip galvanized steel sheet, comprising:
preparing a steel slab having the chemical composition according to claim 17;
hot rolling the steel slab under the conditions with a hot-rolling start temperature of 1,150° C. to 1,270° C. and a finish rolling completing temperature of 830° C. to 950° C. to be formed into a hot rolled steel sheet, which is cooled and then coiled at a coiling temperature of 450° C. to 650° C.; which is pickled;
heating thereafter the pickled steel sheet at an average heating rate of at least 5° C./s to a temperature of 650° C. or above;
holding the heated steel sheet at 730° C. to 880° C. for 15 seconds to 600 seconds;
subsequently cooling the held steel sheet at an average cooling rate of 3° C./s to 30° C./s to a temperature of 600° C. or below;
subjecting thereafter the cooled steel sheet to hot-dip galvanizing process to be formed into a hot-dip galvanized steel sheet; and
cooling the hot-dip galvanized steel sheet to a room temperature.

28. A method of manufacturing a hot-dip galvanized steel sheet, comprising:
preparing a steel slab having the chemical compositions according to claim 18;
hot rolling the steel slab under the conditions with a hot-rolling start temperature of 1,150° C. to 1,270° C. and a finish rolling completing temperature of 830° C. to 950° C. to be formed into a hot rolled steel sheet, which is cooled and then coiled at a coiling temperature 450° C. to 650° C.; which is pickled;
heating thereafter the pickled steel sheet at an average heating rate of at least 5° C./s to a temperature of 650° C. or above;
holding the heated steel sheet at 730° C. to 880° C. for 15 seconds to 600 seconds;
subsequently cooling the held steel sheet at an average cooling rate of 3° C./s to 30° C./s to a temperature of 600° C. or below;
subjecting thereafter the cooled steel sheet to hot-dip galvanizing process to be formed into a hot-dip galvanized steel sheet; and
cooling the hot-dip galvanized steel sheet to a room temperature.

29. The method according to claim 21, further comprising:
subjecting the hot-dip galvanized steel sheet to galvannealing process at a temperature of 450° C. to 600° C. after the hot-dip galvanizing process.

30. The method according to claim 25, further comprising:
subjecting the hot-dip galvanized steel sheet to galvannealing process at a temperature of 450° C. to 600° C. after the hot-dip galvanizing process.
